(19) United States
(12) Patent Application Publication
(10) Pub. No.: US 2002/0149931 A1
(43) Pub. Date: Oct. 17, 2002

(54) Energy-saving conic lamp

(76) Inventor: Ming-Ku Chang, Hsinchu (TW)

Correspondence Address: SUPREME PATENT SERVICES, POST OFFICE BOX 2339, SARATOGA, CA, 95070, US

(21) Appl. No.: 10/118,132

(22) Filed: Apr. 6, 2002

(30) Foreign Application Priority Data
Apr. 16, 2001 (TW) 090205917

(51) Int. Cl. F21V 7/10

(52) U.S. Cl. 362/216

(57) ABSTRACT

An energy-saving conic lamp is constructed substantially in a spiral formation, in which the outer diameter is tapered from the vicinity of the lamp socket to the front end such that the emitted rays of a lighting turn near the socket will not be shaded by a preceding turn to thereby raise the overall brightness of the lamp. For enhancement and evenness of the light projected, a reflective mirror in the inner space surrounded by a spiral lamp formation is arranged to thereby reflect the incident light through a gap between every two immediate neighboring lighting turns.

### FIELD OF THE INVENTION

This invention relates to a high-efficiency energy-saving conic lamp in substitution for an average conventional energy-saving lamp. This invention is structured elaborately in increasing the light-projecting surface area at the front end of a tubular lamp and enhancing the lateral light by centering a reflective mirror inside.

### BACKGROUND OF THE INVENTION

Irrespective of lamp style, no matter a 2U, 3U, 4U, or helical tubular lamp, electric energy is applied to excite some substance inside to have an energy-saving tubular lamp lightened to emanate visible light with intensity in proportion to surface area of the lamp. When the issue for saving energy is considered, light from a pendant lamp is better projected downwards directly instead of being reflected from the ceiling indirectly, which is however not a case used to be.

Taking a 2U, 3U, or 4U lamp for instance (shown in FIG. 1), the lateral area of the lamp is far larger than that of the front end (arrow A), thus the light emanates from the front end is far weaker than that from the lateral area of the lamp, hence it's necessary for the front end to be enhanced with the light reflected or scattered from the ceiling.

A cylindrical lamp (2) tangled with a helical tube shown in FIG. 2 has undoubtedly an enlarged surface area and hence a more intensive luminous density, however, the rays of light (211) adjacent to the lamp socket (21) is completely shaded by a front lamp member, such that the light intensity at the front end is far weaker in proportion than that of the lateral surface. Besides, the rays of light emitted from the inner face of the tubular lamp is mostly shielded by the lamp tube itself and is considered useless.

In summarizing the above, it is obvious that the rays of light pointing along the forward direction is at all events weaker than that pointing laterally. Such a design of lamp in consideration of energy consumption seems deflective to some extent away from the purpose what an energy-saving lamp really means for.

### SUMMARY OF THE INVENTION

The primary objective of this invention is to provide a conic energy-saving lamp that can enhance the light projection to a front end. The conic lamp is substantially a spiral formation, in which the outer diameter is decreased stepwise from the vicinity of the lamp socket to the front end such that the emitted rays of a lighting turn near the socket will not be shaded by a preceding turn to thereby raise the overall brightness of the lamp.

Another objective of this invention is to provide a conic energy-saving lamp having a better efficiency by disposing a reflective mirror in the inner space surrounded by a spiral lamp formation to thereby reflect the incident light through a gap between every two immediate neighboring lighting turns.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 shows a schematic radiation scope of a conventional U style energy-saving lamp;

FIG. 2 shows the formation of a conventional helical energy-saving lamp;

FIG. 3 is a plan view showing the formation of a conic energy-saving lamp of this invention;

FIG. 4 shows a schematic radiation scope of the conic energy-saving lamp of this invention;

FIG. 5 shows a part of cutaway section of the conic energy-saving lamp in another embodiment of this invention;

FIG. 6 shows a cutaway section of a reflective mirror of the conic energy-saving lamp in a yet another embodiment of this invention; and

FIG. 7 shows another cutaway section of the reflective mirror of the conic energy-saving lamp in a yet another embodiment of this invention.

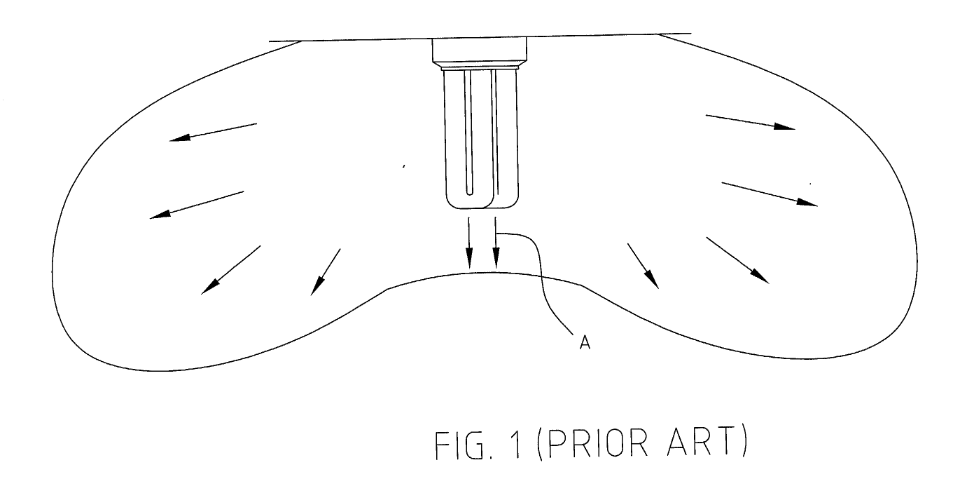

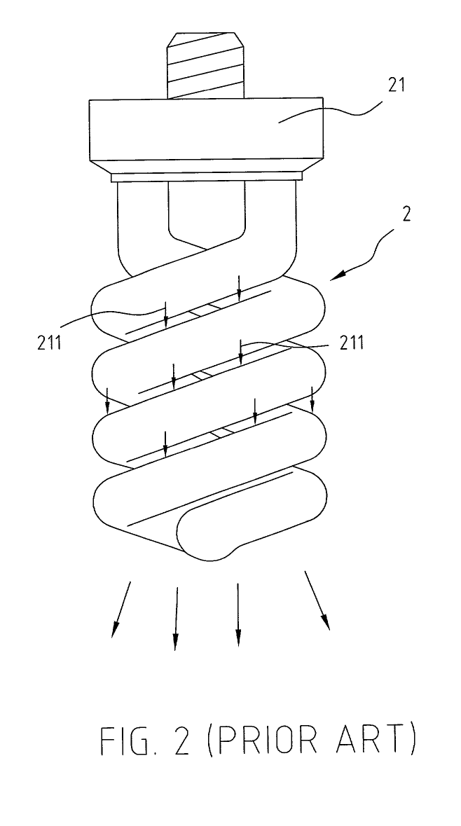

### DETAILED DESCRIPTION OF THE INVENTION

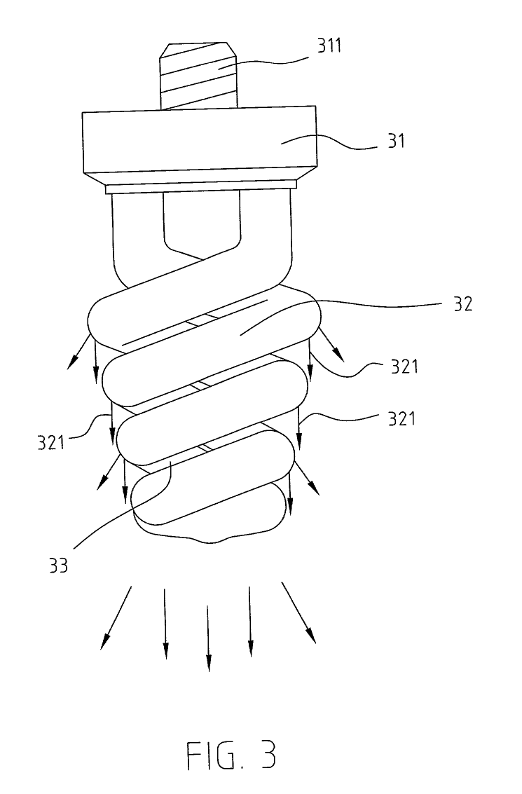

As shown in FIG. 3, a conic energy-saving lamp of this invention comprises a lamp socket (31) and a tubular lamp (32) combined thereto, in which the lamp socket (31) has some electric circuits and electrodes disposed inside and a metallic coupling (311) arranged at one end thereof while some indispensable substance (same as used) is filled in the tubular lamp (32) for lighting after the lamp is duly fixed to a lamp holder.

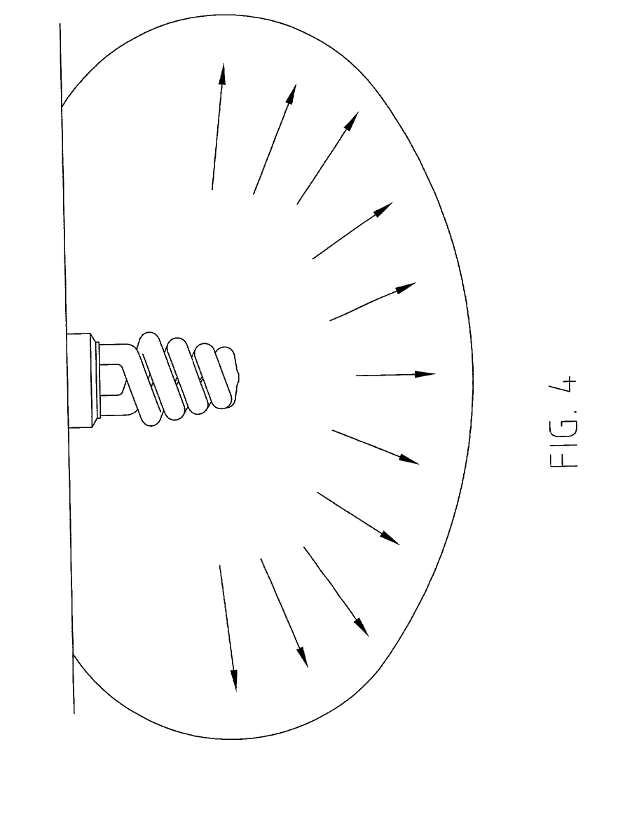

A spiral formation of the tubular lamp (32) is the main specialty of this invention, in which the outer diameter of every lighting turn is sequentially decreased stepwise from the largest one adjacent to the lamp socket toward the smallest one at the front end of the tubular lamp to form an inverse cone; and a gap (33) is reserved between every two immediate neighboring turns. When the lamp is lightened, the rays of light (321) of the lighting turn near the lamp socket (31) can be projected forward (downward in FIG. 3) without being impeded such that a stronger and uniform light projection can be provided (as indicated in FIG. 4).

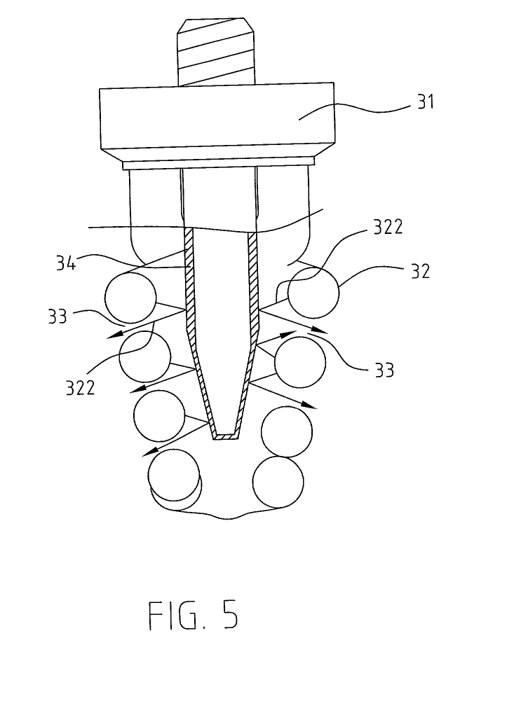

In a cutaway section of the conic energy-saving lamp in another embodiment of this invention shown in FIG. 5, a reflective mirror (34) having a fatter circular upper half part and a conic lower half part is invested by the tubular lamp (32) to form substantially a hollow reflective rod to reflect the incident light beams (322) emitted from the inner face of the tubular lamp (32) to go through the gaps (33), in which the reflective mirror (34) is replaceable to mate with the power and size of different tubular lamps.

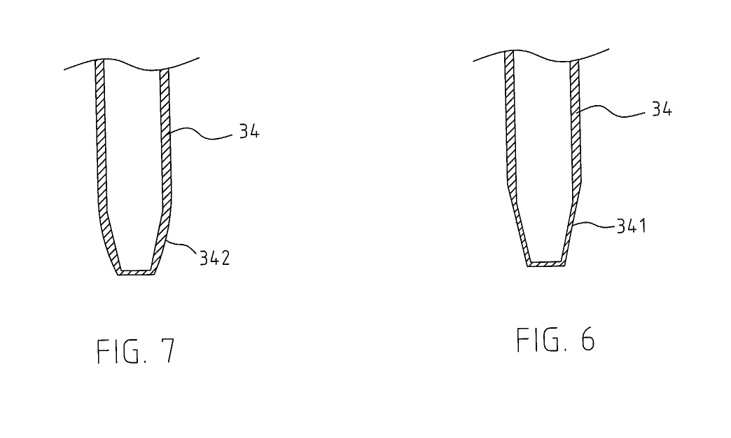

The lower half part of the reflective mirror (34) has a predetermined angle for reflecting the incident light beams in a desired direction, and the reflection mirror might be replaced for variation of the incident angle. In FIG. 6, the lower half part of the reflective mirror (34) is either tapered downward linearly to form a slope (341) or nonlinearly to form an arcuate face (342) for raising lighting efficiency. In addition, the reflective mirror (34) could be formed in a conic shape through and through in stead of the mentioned lower-half conic formation.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. An energy-saving conic lamp, comprising:
a lamp socket having a metallic coupling at one end and related circuits and electrodes inside for combining with a lamp; and
a tubular lamp wound with a spiral lighting tube in turns, in which the formation of the lighting turns is tapered downward from the one adjacent to said lamp socket to form a conic structural body.

2. The energy-saving conic lamp according to claim 1, in which a reflective mirror is resided on said lamp socket and invested in said tubular lamp for reflecting incident light emitted from the inner face of said tubular lamp to go outwardly.

3. The energy-saving conic lamp according to claim 2, in which said reflective mirror is tapered downward linearly to form a conic slope.

4. The energy-saving conic lamp according to claim 2, in which said reflective mirror is tapered downward nonlinearly to form an arcuate face.
